(19) United States
(12) Patent Application Publication
(10) Pub. No.: US 2022/0228707 A1
(43) Pub. Date: Jul. 21, 2022

(54) APPARATUSES FOR HOLDING AND MOUNTING MOBILE DEVICES

(71) Applicant: Chong Y. NG, Seattle, WA (US)

(72) Inventor: Chong Y. NG, Seattle, WA (US)

(21) Appl. No.: 17/153,935

(22) Filed: Jan. 21, 2021

(51) Int. Cl. F16M 13/02; F16M 11/22; F16M 11/04; H04B 1/3877

(52) U.S. Cl. CPC F16M 13/022; H04B 1/3877; F16M 11/041; F16M 11/22

(57) ABSTRACT

The present invention relates to a phone holder that lets users to use it as phone stand on a flat platform or use as a phone mount on a laptop screen. The phone holder is provided with multiple stoppers for accommodating smartphones, phablets, and tablets. In an embodiment of the present invention, the base of the phone holder has flat surface of one side and curved surface on another to aid in proper clamping of the phone holder on thin screens and thick screens. In various embodiments, the phone mounting mechanism is slidably disposed beneath the laptop screen and laptop screen cover such that poles of phone holder can be pulled and slided out by the user when required. The phone holder is also provided with a miniature ball kicker to kick balls to goal between the phone holders vertical poles, thus helping in relaxation and recreation of user.

### FIELD OF THE INVENTION

The present invention relates to a phone holder and more particularly to a phone holding and mounting apparatus that can hold phone in multitude of positions and can also mount the phone on screens and cups.

### BACKGROUND OF THE INVENTION

A phone holder/stand always keeps you organized and gives your hands a well-deserved break. Your phone may make you work a lot on its safety, cleanliness and at the same time, you need to work on your comfort and productivity as well. But all of this is made easy by the presence of a phone holder or stand.

It can be really tiring for a user to hold up his phone for hours in his hands to watch your favorite videos. As a matter of fact, a cell phone can weigh around 0.3 pounds and may make a user uncomfortable and reduce his productivity if he is not using phone holders or phone stand.

Several prior attempts to deal with such problems have been utilized as set forth below.

U.S. Pat. No. 9,432,071 B2 to Jaehyun et. al. discloses a smart phone holder that include a docking portion formed on a panel in a vehicle cabin and provided with an electric terminal, a supporter detachably mounted on the docking portion and provided with a power pin corresponding to the electric terminal, a cradle provided with a rear surface mounted on a front surface of the supporter, a supporting cradle disposed at an end of the cradle and configured to support an end of a smart phone, a moving unit mounted in the cradle, and configured to slide the supporting cradle from or to the end of the cradle corresponding to a size of the smart phone.

U.S. Pat. No. 10,155,482 B2 to Corso et. al. discloses a combination cup and cellular phone holder assembly for holding and mounting a cellular phone within an automotive cup holder is disclosed wherein the cellular phone is always conveniently located with respect to the driver or passenger within the automotive vehicle cabin.

United States Patent Publication No. 2014/0061406 A1 discloses a system that permits various accessories to be attached to a computer monitor, allowing a user to save valuable desk space. The system of the present invention includes one or more accessory holders that can hold, for example, a cell phone, pens, eyeglasses, mirrors, photos, earphones, remote controls, photos, and the like.

U.S. Pat. No. 8,706,175 B2 to Cho et. al. discloses a phone and tablet stand that includes a rotatable mounting head that attaches a tablet to the phone and tablet stand, attachment magnets that are evenly disposed on a rotatable mounting head to magnetically attach a tablet to the phone and tablet stand and an adjustable stand that includes a stem and a pair of adjustment knobs.

However, cell phone holders currently available to consumers do not provide cell phone stand and cell phone mounting mechanism in one cell phone holder. There is accordingly a need for a cell phone holder that provide both the cell phone stand and cell phone mounting mechanism as one apparatus thus eliminating the need of user of buying cell phone stand and cell phone holder separately.

### SUMMARY OF THE INVENTION

In an embodiment of the present invention, a light weight and compact phone holder is disclosed which enables user to keep their mobile phone, phablet or tablet on a phone stand stabilized on a flat surface or mount on the top edge of laptop screen for easy viewing and usage while the device is charging.

The object of the present invention is to provide a minimalistic phone holding and mounting apparatus that allows a user to mount the phone on upper edge of laptop screen to view and access content or application on phone simultaneously while working on the laptop.

It is also an object of the present invention, when two users communicate over a video conference, frontal viewing is very important to promote eye to eye contact therefore this phone mounting apparatus is configured to not to obstruct the webcam of laptop when mounted in the middle of the upper edge of the laptop screen.

In an embodiment of the present invention, in order to secure the phone or tablet in place at the top edge of the laptop screen the pair of hooks or forks with the help of magnets present at poles or phone hand grip (in some embodiments) to place the phone or tablet in landscape or portrait format whichever the user wants.

It is yet another object of the present invention, to provide a phone holding and mounting apparatus that enables the user to plug the charging cable to the charging receptor of their device regardless of the orientation in which it is held by the phone holder or mounted by it on the laptop screen.

In an embodiment of the present invention, the phone holding and mounting apparatus can be folded or unassembled into three individual parts for easy storage to make it compact and travel friendly.

In another embodiment of the present invention, the phone holding and mounting apparatus can retract or collapse back within the vent made between the screen and screen back cover of a laptop or a computer monitor.

It is an object of the present invention to provide a phone holding and mounting apparatus that can—sit on a platform, allow users to display their photo, favorite team logo, business card etc. on top of phone or tablet with help of mini billboard holder wherein the bill board holder will be made of long wire or spring with the end looking and working like a paper clip, can be used as an American football goal pole for entertainment between work. The phone holder will be provided with a miniature projectile launcher to launch a football to goal between two poles of phone holder.

In an embodiment of the present invention, the base of the apparatus is magnetized thus allowing the user to stick it to metal surface also. When phone holder is mounted on upper edge of the laptop screen the magnetized base allows the mounted phone holder to deal with angle with help of an adhesive plate.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 is a perspective view of phone holder wherein the base insert is in the base opening according to one or more aspects of an illustrative embodiment of the invention;

FIG. 2 is a perspective view of phone holder wherein the base insert is in the base insert storage according to an embodiment of the present invention;

FIG. 3 is a side view of phone holder wherein the base insert is in the base insert storage according to an embodiment of the present invention;

FIG. 4 illustrates a front perspective view of phone holder supporting phone in portrait position wherein charging cable is plugged in from the front side according to an embodiment of the present invention;

FIG. 5 illustrates a front perspective view of phone holder supporting phone in portrait position wherein charging cable is plugged in from the rear side according to an embodiment of the present invention;

FIG. 6 illustrates a front perspective view of phone holder mounted on screen of laptop;

FIG. 7 illustrates an exemplary embodiment of phone holder offering billboard facility with help of mini billboard holders inserted in the upper billboard holder slot;

FIG. 8 illustrates an exemplary embodiment of phone holder offering billboard facility with help of mini billboard holders inserted in the lower billboard holder slot;

FIG. 9 illustrates an exemplary embodiment of the present invention, wherein the phone holder is mounted on cup;

FIG. 10 illustrates an exemplary embodiment of the magnetized U-type phone holder slidably disposed in the laptop cover;

FIG. 11 illustrates an exemplary embodiment of the magnetized single pole circular type phone holder slidably disposed beneath the laptop cover;

FIG. 12 illustrates an exemplary embodiment of the rectangular loop type phone holder slidably disposed beneath the laptop cover;

FIG. 13 illustrates an exemplary embodiment of the magnetized swivel bars type phone holder wherein bars are pivotally mounted beneath the laptop cover;

FIG. 14 illustrates a perspective view of the miniature ball kicker provided with the phone holder in accordance with an embodiment of the present invention;

FIG. 15 illustrates an exemplary embodiment of the miniature ball kicker kicking ball to goal between the vertical poles of phone holder;

FIG. 16 illustrates a perspective side view of the phone holder supporting phone equipped with popup grip;

FIG. 17 illustrates a perspective rear view of a magnetized single pole circular type phone holder holding a phone equipped with a popup grip having a metallic cap or magnetized cap.

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

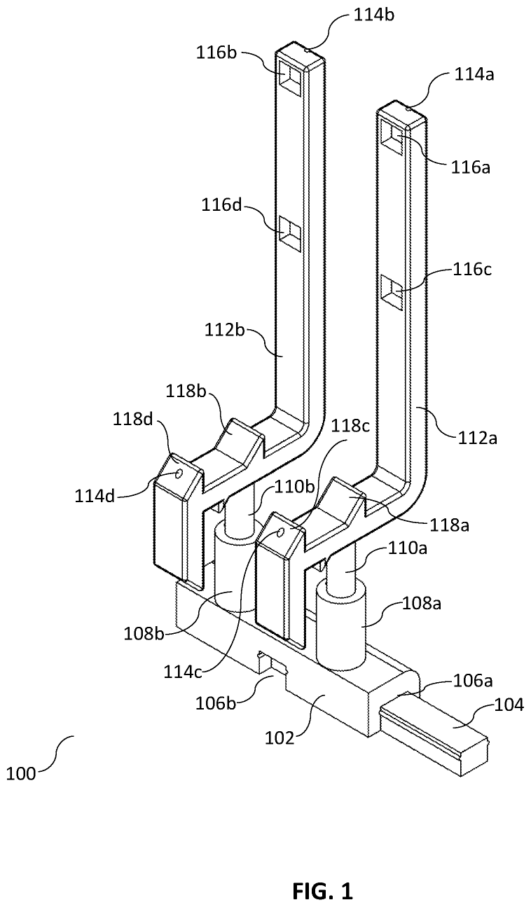

With reference now to the drawings, and in particular to FIG. 1 to FIG. 17 thereof, a phone holding and mounting apparatus embodying the principles and concepts of the present invention is described.

Reference is made now to FIG. 1, illustrating an exemplary embodiment 100 of the phone holder mainly comprising of three parts that are pair of vertical poles, base and base insert which can be assembled or dissembled by user when needed.

In an embodiment 100 of the present invention, the phone holder comprises a base 102 that has a cuboidal structure with one flat side surface and a curved opposite side surface wherein the cuboidal base 102 has two base insert openings such that first base opening 106a run across the length of the cuboidal base 102 and second base opening 106b run across the width of the cuboidal base 102 such that it is perpendicular to the length of the cuboidal base. When phone holder is not in use or it is mounted upon a laptop screen the base insert opening 106a provides a storage to slide and store base insert 104 beneath the base 102.

The base 102 has two pole holders—pole holder 108a and pole holder 108b both affixed upon the top surface of the base 102 for holding the vertical poles. The pole holder 108a and pole holder 108b have hollow tubular structure configured to accommodate rounded center poles of the vertical poles. As illustrated in FIG. 1, the rounded center pole 110a of the vertical pole 112a is inserted in the pole holder 108a. Likewise, the rounded center pole 110b of the vertical pole 112b is inserted in the pole holder 108b. The rounded center poles 110a and 110b are rotatably mounted in the pole holders 108a and 108b to facilitate independent rotation of the vertical poles 112a and 112b when required by the user.

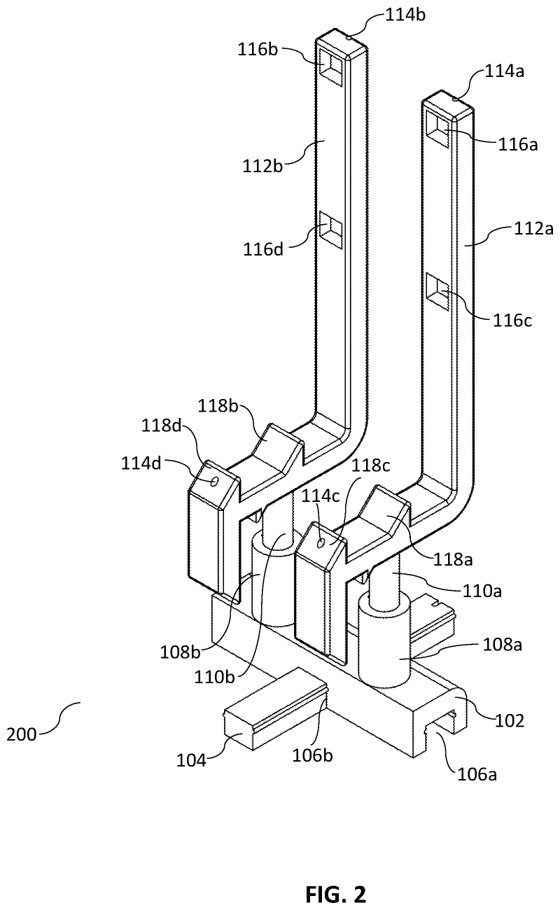

Reference is made now to FIG. 2, illustrating an exemplary embodiment 200 of the phone holder wherein the base insert 104 is inserted in the base insert opening 106b for placing and stabilizing phone holder 100 on a flat surface. In an embodiment of the present invention, the base 102 is magnetized to facilitate planting and sticking of the phone holder on metal platforms. In an embodiment of the present invention, the base insert 104 will have magnets placed in its magnet slots present at the bottom surface.

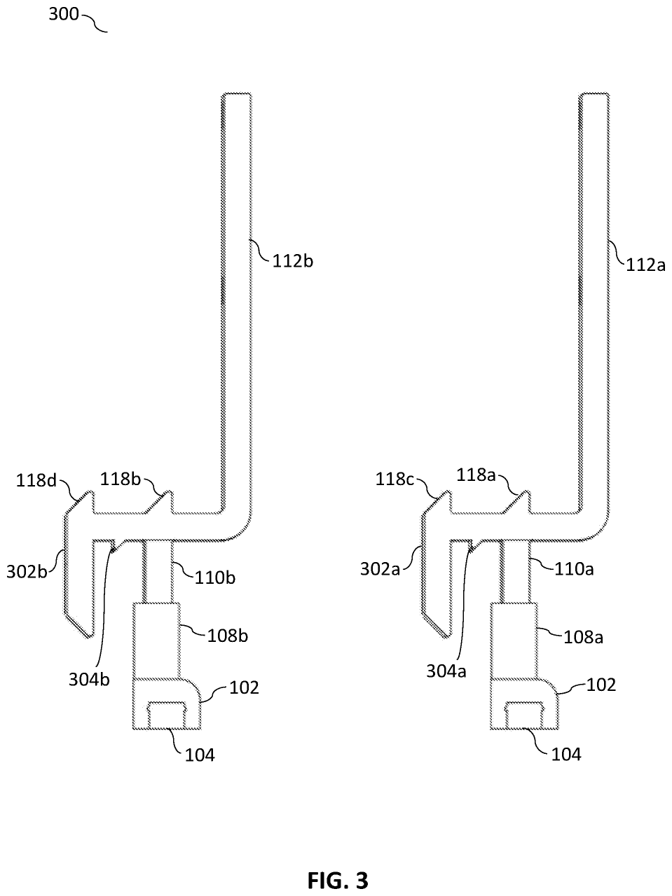

Reference is made now to FIG. 3, illustrating side views embodiment 300 of the phone holder. In an embodiment of the present invention, each vertical pole comprises of first billboard holder slot, first magnet slot, second magnet slot, first stopper, second stopper, hook, second billboard slot, a third stopper that is a thin screen stopper and rounded center pole.

As illustrated in the FIG. 1, FIG. 2 and FIG. 3, the vertical pole 112b comprises of first billboard holder slot 114b, first magnet slot 116b, second magnet slot 116d, first stopper 118b, second stopper 118d, second billboard holder slot 114d, hook 302b, third stopper 304b and rounded center pole 110b. The vertical pole 112a comprises of first billboard holder slot 114a, first magnet slot 116a, second magnet slot 116c, first stopper 118a, second stopper 118c, second billboard holder slot 114c, hook 302a, third stopper 304a and rounded center pole 110a.

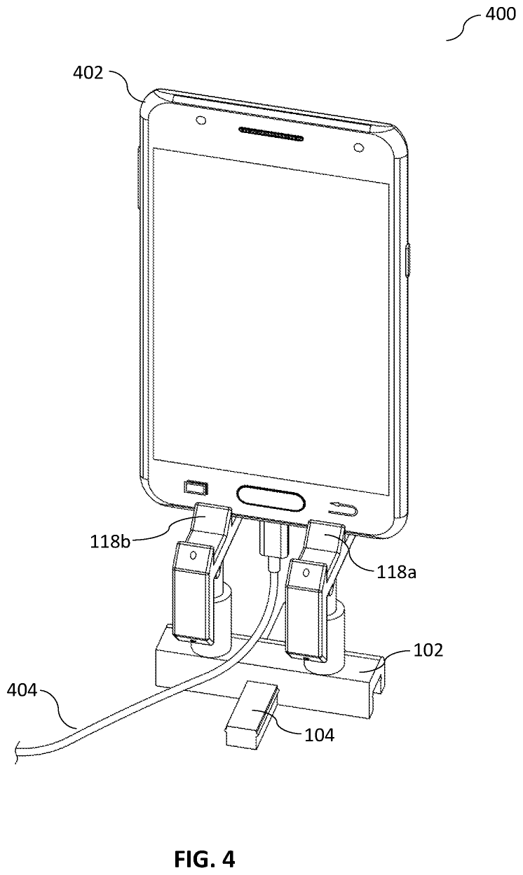

Reference is now made to FIG. 4, illustrating a front perspective view of phone holder holding phone in portrait position supported by pair of first stoppers 118a and 118b. In the embodiment 400 the phone 402 placed on phone holder is plugged in with charging cable 404 coming from the front.

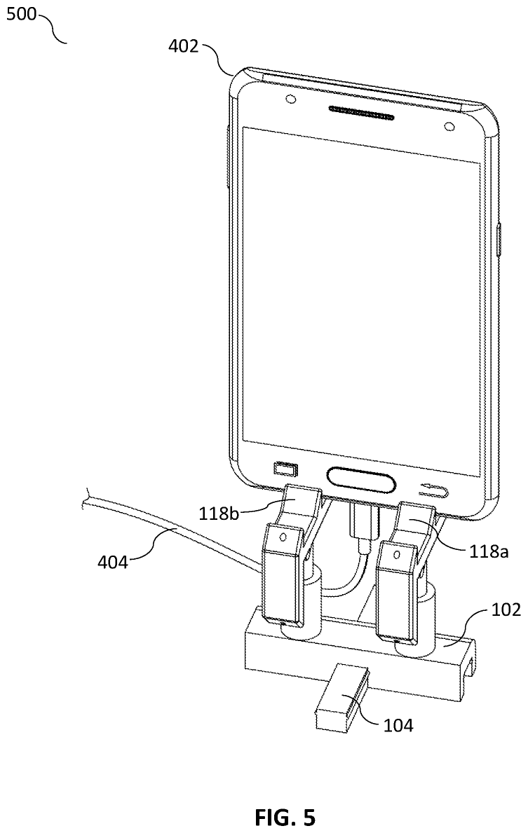

Reference is now made to FIG. 5, illustrating a front perspective view of phone holder holding phone 402 in portrait position supported by pair of first stoppers 118a and 118b. In the embodiment 400 the phone 402 placed on phone holder is plugged in with charging cable 404 coming from the rear side.

The phone holder is configured to facilitate charging of smartphone 402 regardless of the orientation in which it is kept. Embodiments 400 and 500 illustrates that the charging cable 404 can be plugged into phone 404 mounted on phone holder from any side.

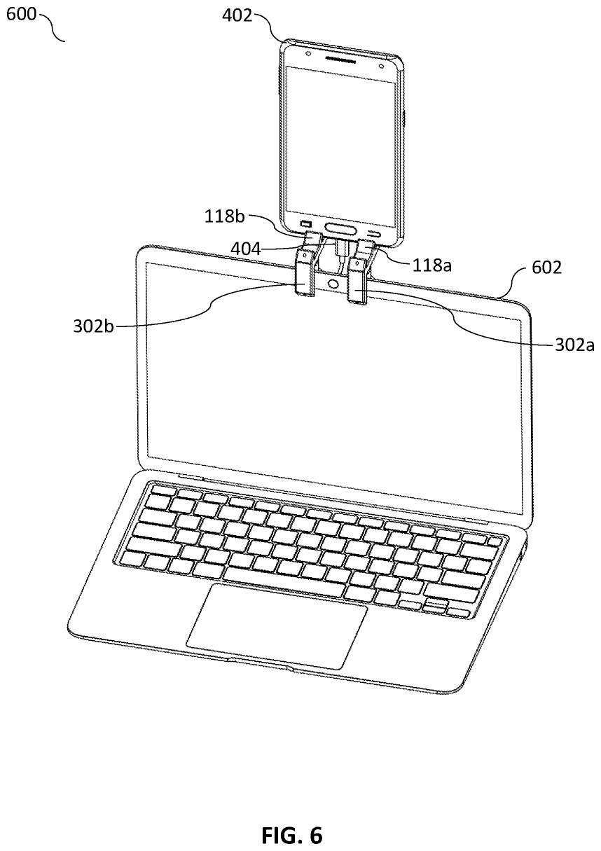

Reference is now made to FIG. 6, illustrating an exemplary embodiment 600 of phone holder mounted on screen of laptop 602. The pair of hooks 302a and 302b of phone holder and the base 102 facilitates clamping of phone upon the upper edge of the screen of laptop 602. The structure of phone holder allows the user to place phone holder in middle of the upper edge of the screen of laptop 602 without obstructing the camera of laptop 602 which is required during video conferences as user like to maintain eye contact with the person on the other side instead of looking away elsewhere. Also, being able to mount the phone 402 in middle of upper edge of the screen of laptop helps user in increasing his or her productivity during work as the user would be able to look at both the laptop screen and phone screen simultaneously. The phone mounting position as illustrated in embodiment 600 allows user to charge the phone 402 while it is kept on the phone holder thus allowing the user to also charge his phone while it is mounted upon laptop screen.

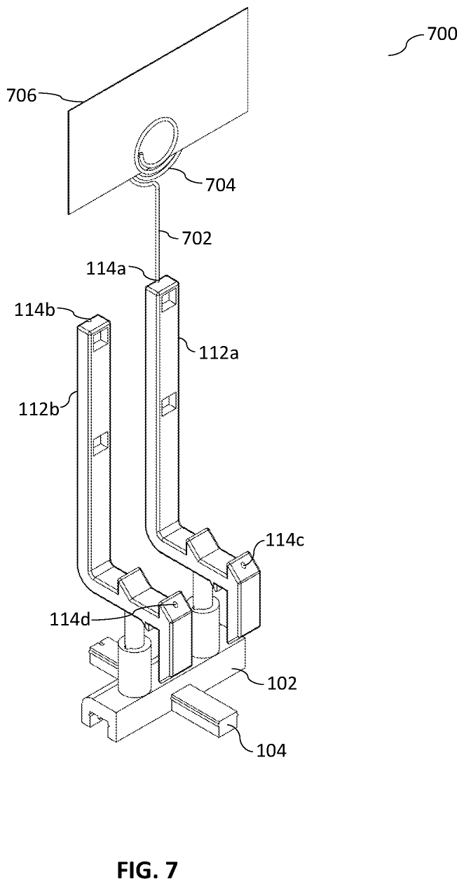

Reference is made now to FIG. 7, illustrating an exemplary embodiment 700 of phone holder offering billboard facility with the mini billboard holder 702 inserted in the upper billboard slot 114a. The mini billboard holder 702 is a structure made from semi-stiff wire with one straight end for inserting in any billboard holder slot and other end having spiral paper clip 704 for holding variety of objects like business cards, logos, advertisement flyers or a flower. In alternative embodiments, spiral shape may be replaced by other shape of clips.

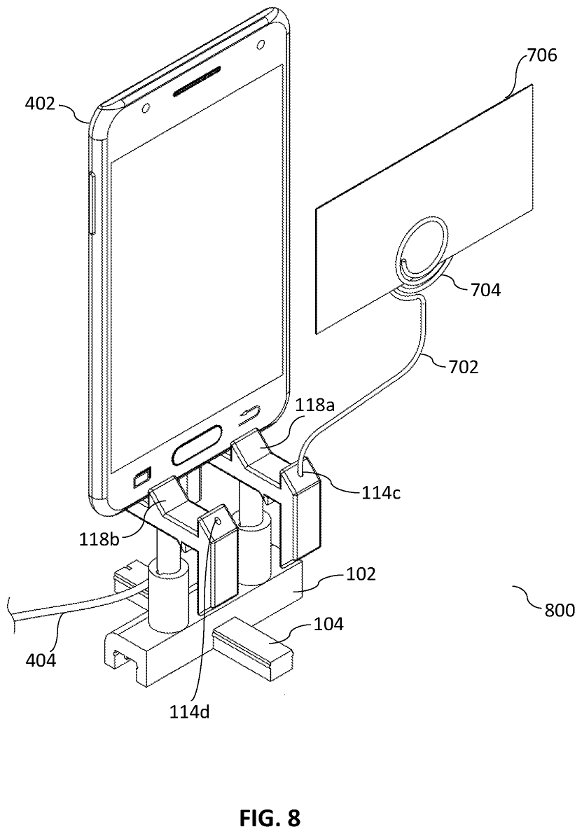

Reference is made now to FIG. 8, illustrating an exemplary embodiment 800 of phone holder offering billboard facility with the mini billboard holder 702 inserted in the lower billboard slot 114c. The phone holder is provided with multiple billboard holder slots wherein 114a, 114b are upper billboard holder slots and 114c,114d are lower billboard slots.

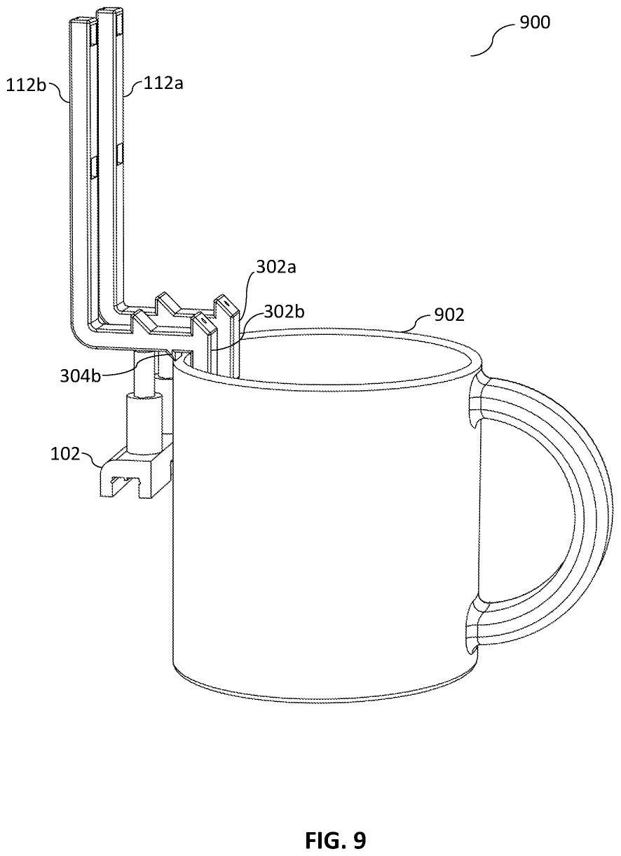

Reference is made now to FIG. 9, illustrating an exemplary embodiment 900 wherein the phone holder is mounted on a cup 902. The pair of hooks 302a and 302b with base 102 act as a clamp on the circular edge of the cup 902.

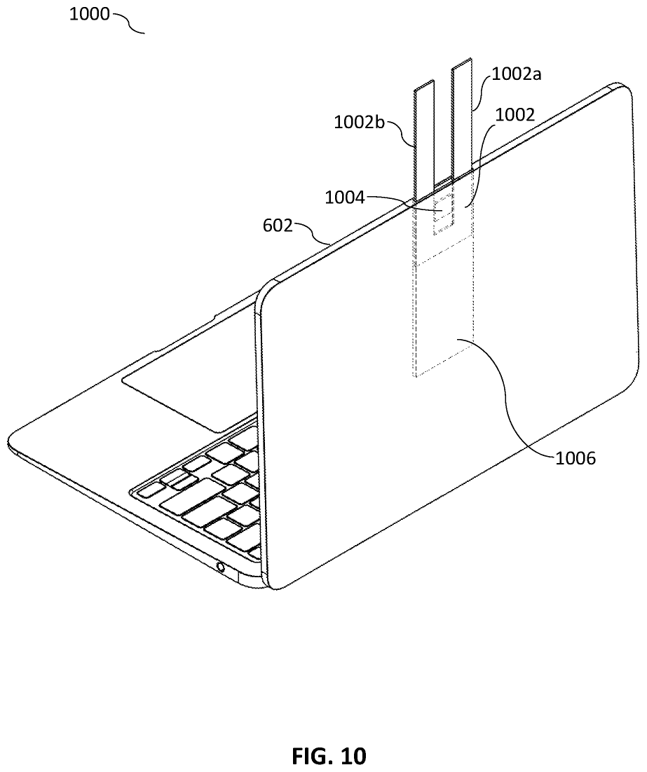

Reference is made now to FIG. 10, illustrating an exemplary embodiment 900 wherein the phone holding mechanism is slidably disposed beneath the screen cover of laptop 602. The laptop is provided with a cavity 1006 between the screen cover of laptop and the screen of laptop such that the U-shaped phone holder can slide in and out of the upper edge of the laptop screen. A stopper 1004 is affixed beneath the screen cover between the two poles 1002a and 1002b of the phone holder to stop phone holder 1002 from coming out of the laptop screen. The phone holder 1002 is a thin but stiff U-shaped structure with thickness less than the thickness of laptop screens.

In an embodiment of the present invention, when the user wants to use the phone holder 1002, the user just has to grab and pull one of the poles of U-shaped structure, the poles of phone holder will come out to mount phone on it. The U-shaped phone holder has magnetized arms having strong magnetic power to hold phone equipped with a metallic or magnetic popup. In an embodiment of the present invention, a metallic or magnetic disk will be provided with phone holder to change the upper magnetic disk of previous popup grip or the user can also just peel off the glued paper on provided metallic or magnetic disk to stick it to the back of the phone.

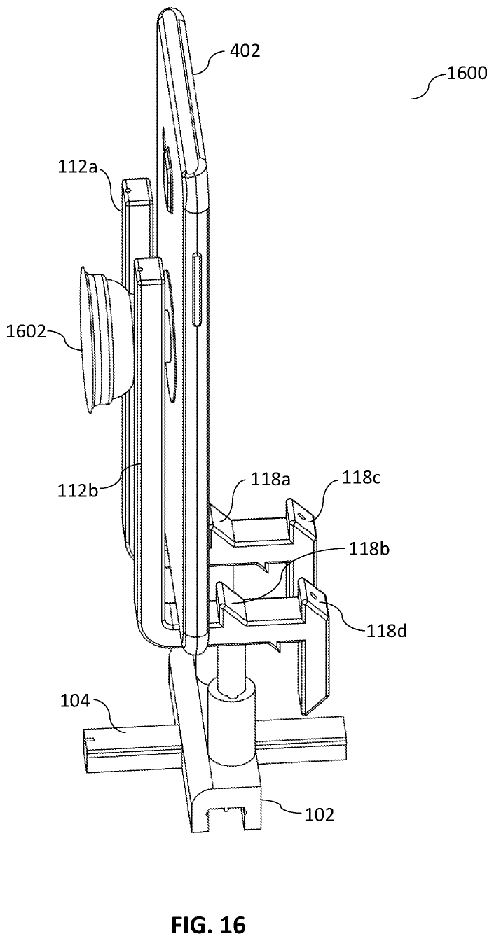

In embodiments of the present invention, wherein the user doesn't have magnetic popup grip user can also keep the phone on phone-holder by popping up the normal popup grip of phone and sliding it between the two vertical poles (1002a and 1002b) of the phone holder (as shown in FIG. 16).

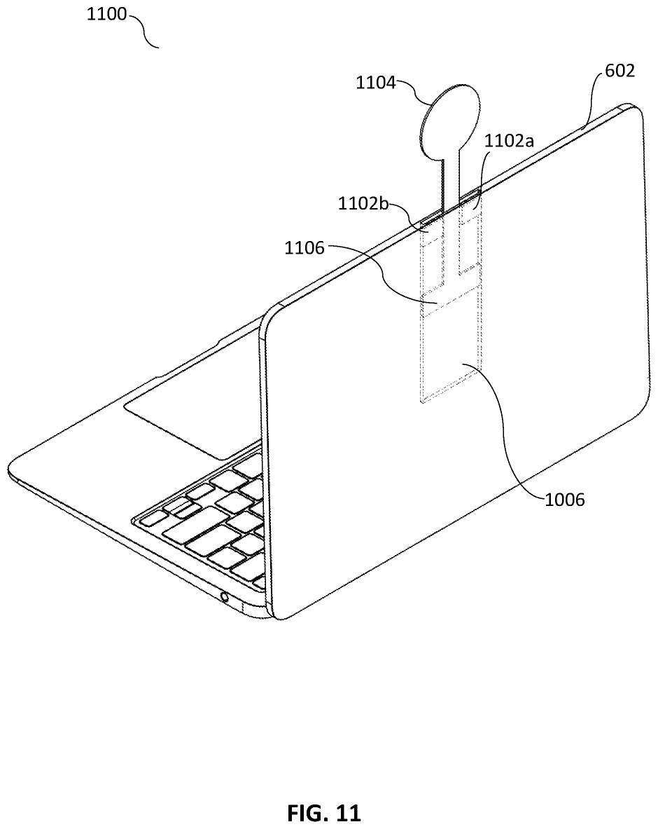

Reference is now made to FIG. 11, illustrating an exemplary embodiment 1100 of the magnetized single pole circular type phone holder slidably disposed beneath the laptop cover. The phone holder 1104 has circular disk on one end and a T-shaped hook on other end. The phone holding mechanism is provided with pair of stoppers 1102a and 1102b on both side of phone holder 1104 to stop phone holder from coming out of the screen. The phone holder 1104 can be slided back inside the cavity 1006 when not in use.

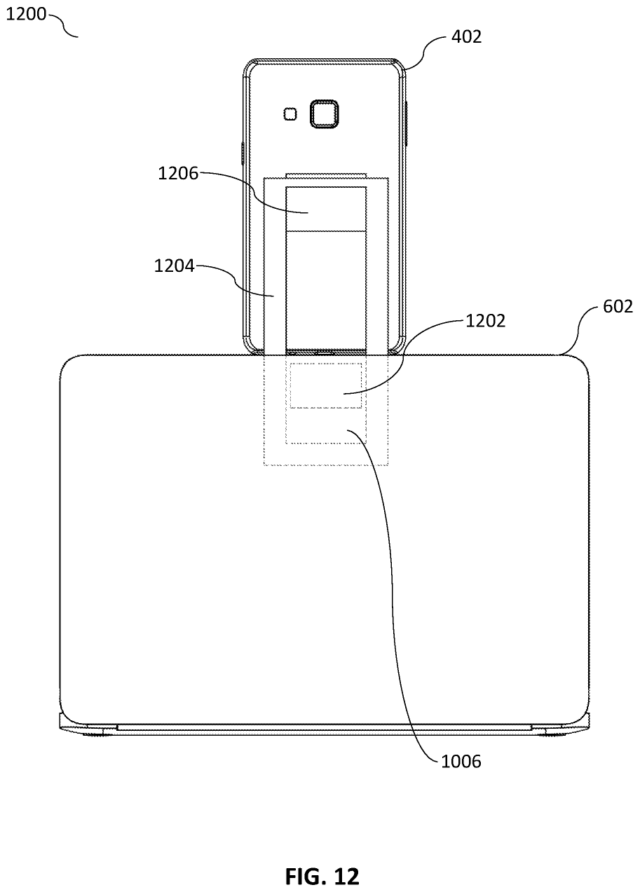

Reference is now made to FIG. 12, illustrating an exemplary embodiment 1200 of the rectangular loop type phone holder 1204 comprising a magnet 1206 at upper end of the loop to hold phone 402 by its metallic or magnetic cap equipped popup grip. The rectangular loop type phone holder 1204 is provided with a stopper 1202 affixed between its structure to stop phone holder from coming out from the screen.

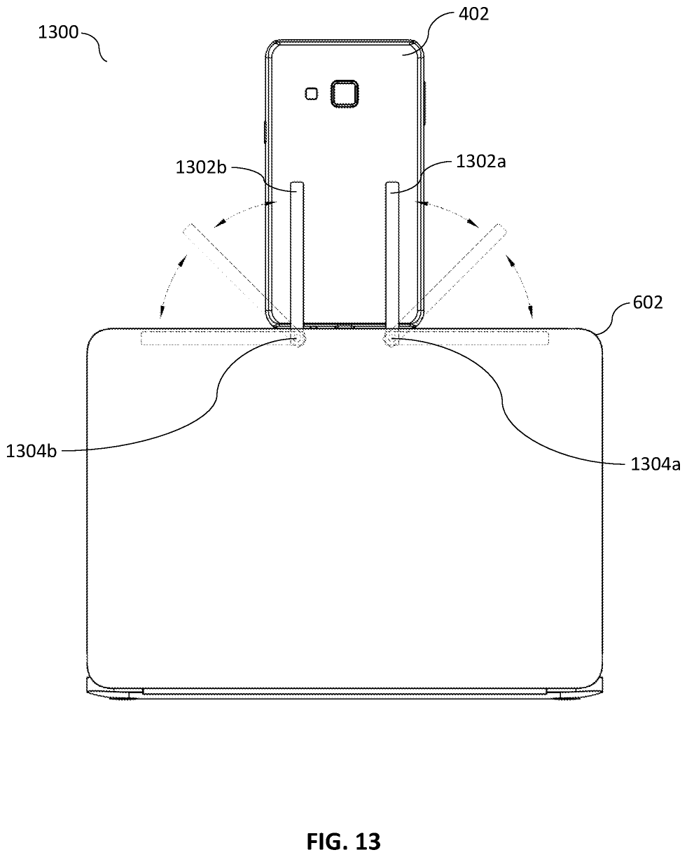

Reference is now made to FIG. 13, illustrating an exemplary embodiment 1300 of the magnetized swivel bar type phone holder wherein bars are pivotally mounted at pivotal mounts 1302a and 1302b beneath the laptop cover. The magnetic swivel bars 1302a and 1302b can be swiveled to vertical standing position when user want to mount the phone and swiveled back inside the laptop screen when not in use.

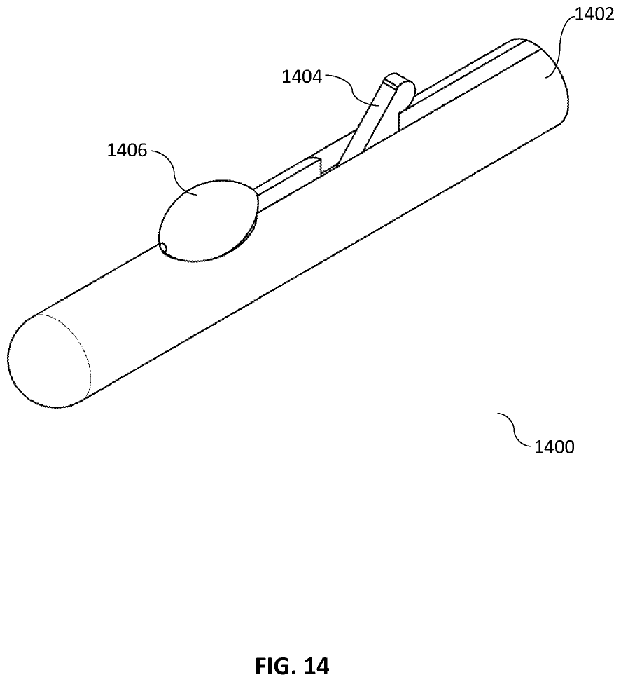

Reference is now made to FIG. 14, illustrating an exemplary embodiment 1400 of the miniature ball kicker 1402 that will be provided with the phone holder to let user play and time pass when the user is bored. The miniature ball kicker 1402 comprise of tubular body having a rod-shaped piston inserted inside it. The rod-shaped piston has a spring inserted into the back of the rod-shaped piston behind the kicker 1404 which has preferably a triangular shape or may any angular shape. The rod is suspended inside the tubular body by inserting its ends to two circular holders present inside the ball kickers 1402 body. The two internal circular holders that receives the rod and allow the rod to slide back and forth.

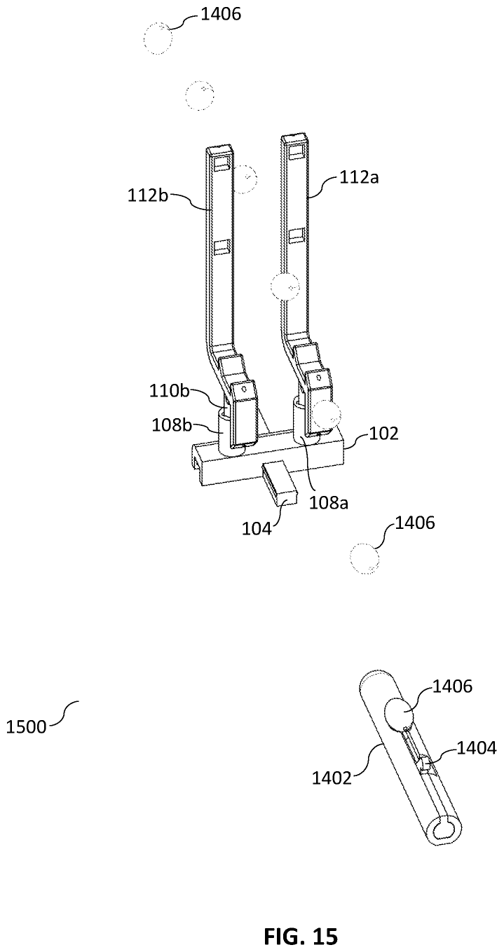

In order to use the ball kicker, the user has to hold on to the kicker and drag it back forcing the spring to compress. The kicker will catapult in forward direction resulting in kicker punching the ball 1406 forward (as shown in FIG. 15).

Reference is now made to FIG. 15, illustrating an exemplary embodiment 1500 wherein the ball kicker 1402 kicks the ball 1406 when kicker button 1404 is pressed to goal between the vertical poles 112a and 112b of phone holder. The gap between the vertical poles 112a and 112b can be increased by swiveling them on the pole holders 108a and 108b affixed on base 102.

Reference is now made to FIG. 16, illustrating an exemplary embodiment 1600 wherein the phone 402 equipped with popped-up grip 1602 is placed on the phone holder. The popped-up grip 1602 is hooked between the vertical poles 112a and 112b to keep phone 402 stuck in its place.

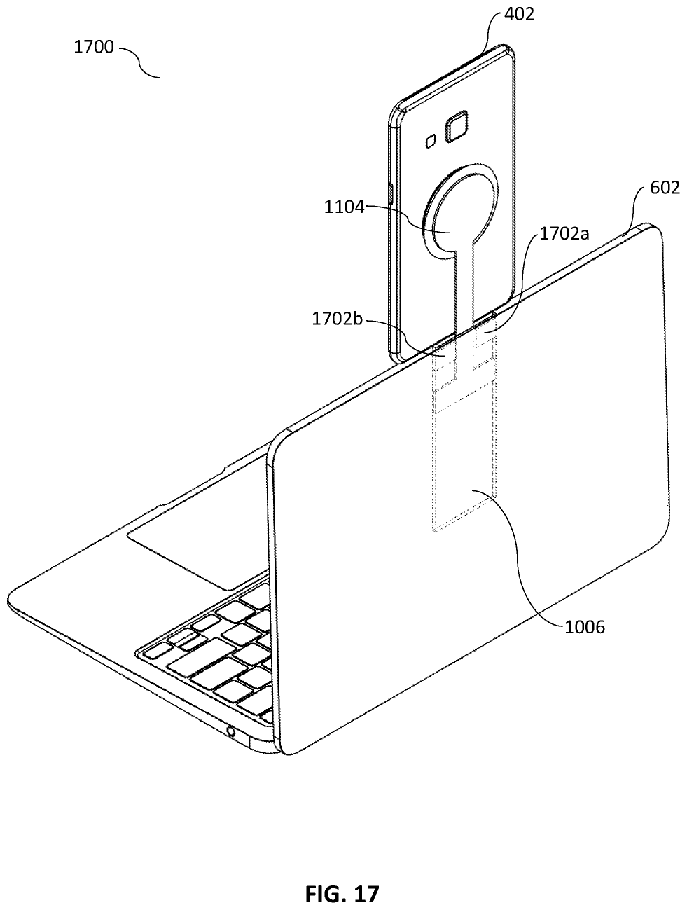

Reference is now made to FIG. 17, illustrating an exemplary embodiment 1700 wherein the phone 402 equipped with popup grip or metallic disk or magnetic disk on its back surface is placed on the single pole phone holder 1104. The magnetic circular disk of the single pole phone holder 1104 facilitates sticking of popup grip/metallic disk/magnetic disk present at the back surface of the phone to stick phone on the single pole phone holder 1104.

By virtue of implementing the above embodiments, the invention provides a cell phone holder that can work as both cell phone stand and cell phone mounting mechanism. Specific advantages of the phone holder include:
providing cell phone holding and mounting mechanism in one apparatus, providing the facility of using mini billboard holders;
providing pair of multiple of stoppers for accommodating bigger smart devices like phablets and tablets;
providing an apparatus that can clamp perfectly on both thin and thick screens;
providing an apparatus that can clamp on coffee cup;
providing swivel mechanism in the stand to tilt the view of phone sitting upon it;
providing an apparatus that can hold phone in both portrait and landscape orientation;
providing an apparatus that allows charging of phone regardless of the orientation and configuration in which the phone is kept on phone holder;
providing an apparatus that is able to mount phone with or without popup grip;
providing a phone mounting mechanism that is slidably disposed between the laptop's screen and screen cover;
providing a ball kicker that works in combination with the phone stand for entertainment.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular embodiment specifically contemplated, is intended to be practiced in the absence of any element which is not specifically disclosed herein.

1. An apparatus for holding and mounting smartphone, the apparatus comprising:
a cuboidal base with one flat side surface and a curved opposite side surface wherein the cuboidal base has two base insert openings such that first base opening run across length of the cuboidal base and second base opening run across the width of the cuboidal base such that it is perpendicular to the length of the cuboidal base;
a pair of vertical poles wherein each vertical pole further comprises of a first billboard holder slot, a first magnet slot, second magnet slot, a first stopper, a second stopper, a hook, a second billboard, a third stopper and a rounded center pole;
a pair of pole holders affixed vertically upon the surface of the cuboidal base wherein each pole holder has hollow tubular structure configured to accommodate rounded center pole of the vertical pole such that the rounded center poles are rotatably mounted in the pole holders to facilitate independent rotation of the vertical poles in any direction.

2. An apparatus for holding and mounting smartphone according to claim 1, wherein when phone holder is not in use or it is mounted upon a laptop screen or a cup the base insert is inserted in the first base opening that provides a storage to slide and store the base insert beneath the base.

3. An apparatus for holding and mounting smartphone according to claim 1, wherein the base insert when inserted in the second base insert opening of the base stabilizes the phone holder on a flat platform.

4. An apparatus for holding and mounting smartphone according to claim 1, wherein the phone holder has pair of first stoppers to support the phone in portrait or landscape position.

5. An apparatus for holding and mounting smartphone according to claim 1, wherein the phone holder has pair of second stoppers to support the phone in tilted position.

6. An apparatus for holding and mounting smartphone according to claim 1, wherein the phone holder has pair of third stoppers that aid in proper clamping of phone holder on thin screens.

7. An apparatus for holding and mounting smartphone according to claim 1, wherein the phone sitting on phone holder regardless of the orientation can be charged by plugging in with charging cable coming from front side, rear side, left side or right side.

8. An apparatus for holding and mounting smartphone according to claim 1, wherein the pair of hooks and base of the phone holder aid in clamping of phone holder on the upper edge of the screen.

9. An apparatus for holding and mounting smartphone according to claim 1, wherein the phone holder when mounted in the middle of the upper edge of the screen of laptop does not obstruct camera of laptop due to space between the hooks that clamp with base on the laptop screen.

10. An apparatus for holding and mounting smartphone according to claim 1, wherein the pair of hooks and base of the phone holder aid in clamping of phone holder on the upper edge of the cup.

11. An apparatus for holding and mounting smartphone according to claim 1, wherein the flat base of the phone holder faces screen cover if screen is thick and curved base of the phone holder faces the screen cover if screen is thin.

12. An apparatus for holding and mounting smartphone according to claim 1, wherein the phone holder has billboard holder slot each on the tip of vertical poles and on stoppers for inserting mini billboard holders made of stiff wire.

13. An apparatus for holding and mounting smartphone according to claim 1, wherein the phone when equipped with popped-up grip is placed on phone holder by hooking the popped-up grip between the vertical poles of phone holder to keep the phone stuck in its place.

14. An apparatus for holding and mounting smartphone wherein the phone holding and mounting mechanism is slidably disposed in the cavity between the screen and screen cover of laptop such that the phone holding and mounting mechanism can be slided out from the vent present at the edge of laptop when needed to mount the phone and slided back inside the laptop screen when not in use.

15. An apparatus for holding and mounting smartphone according to claim 14, wherein the phone holder embedded inside the laptop screen has a magnetized stiff plate structure.

16. An apparatus for holding and mounting smartphone according to claim 14, wherein the phone holder can have dual pole U-shaped, single pole circular type, rectangular loop type or swivel bar type structure.

17. An apparatus for holding and mounting smartphone according to claim 14, wherein the magnetized pole of phone holder provides facilitates sticking of smartphone equipped with popup grip having metallic disk or a magnetic disk cap.

18. A phone holder kit comprising miniature ball kicker for entertainment, wherein the ball kicker comprises of tubular body having a rod-shaped piston suspended inside on two circular holders present inside the said ball kickers body such that the two internal circular holders allow the rod-shaped piston to slide back and forth through a spring inserted into the back of the rod-shaped piston behind the triangular shaped kicker.

19. A miniature ball kicker according to claim 18, wherein the user has to hold on to the kicker and drag it back forcing the spring to compress as a result kicker catapult in forward direction resulting in kicker punching ball forward.
